(19) United States
(12) Patent Application Publication
(10) Pub. No.: US 2022/0205396 A1
(43) Pub. Date: Jun. 30, 2022

(54) ENGINE TORQUE CONTROL

(71) Applicant: ORBITAL AUSTRALIA PTY LTD, Balcatta (AU)

(72) Inventor: Richard Albert George WOOLFORD, Connolly (AU)

(73) Assignee: ORBITAL AUSTRALIA PTY LTD, Balcatta (AU)

(21) Appl. No.: 17/429,186

(22) PCT Filed: Feb. 7, 2020
(86) PCT No.: PCT/AU2020/050102

§ 371 Date: Aug. 6, 2021

(30) Foreign Application Priority Data
Feb. 7, 2019 (AU) 2019900395

(51) Int. Cl. F02D 41/00; F02D 31/00

(52) U.S. Cl. CPC F02D 41/0002; B64C 39/024; F02D 31/007

(57) ABSTRACT

Disclosed is a method of controlling an internal combustion engine (102) of a UAV (100), and also disclosed is a UAV engine system (101), The engine (102) has a fuel delivery means (123) operable to deliver a fuel to a combustion chamber of the engine, and an air flow control means (107) for regulating air flow to the combustion chamber. The method comprises controlling the engine (102) through control of fuelling by way of the fuel delivery means (123) independently of the air flow control means (107), including determining a fuelling requirement for the engine based on a request from a flight control system, and determining an air flow requirement based on or with reference to the fuelling requirement. This provides for fuel-led control of the engine system (101). Specifically, a fuelling requirement for the engine (102) is determined and implemented, and the corresponding air requirement is then determined contingent upon the fuelling requirement.

### TECHNICAL FIELD

This invention relates to operation of an internal combustion engine of an unmanned aerial vehicle (UAV).

More particularly, the invention is concerned with a method of controlling an internal combustion engine of a UAV, and an engine system for an internal combustion engine of a UAV. The invention is also concerned with a UAV powered by an internal combustion engine controlled by such a method, the internal combustion engine forming part of the overall engine system.

### BACKGROUND ART

Discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

With an internal combustion engine of a UAV, engine torque and speed can be selectively increased or decreased as required by control of intake fluid (i.e. intake air or an air-fuel mixture) delivered to the combustion chamber(s) of the engine. The control of the intake fluid is commonly effected by way of a throttle, with the throttle setting (e.g. the angular position of a throttle valve) regulating flow by varying the extent of restriction to flow presented by the throttle. The fuel required to power the engine is supplied by way of a fuel delivery means, and the air and fuel are matched to meet a specific air-fuel ratio to produce the requisite engine power and speed. The air flowing into the engine is controlled (by the throttle) and the fuel delivery means reacts by supplying the requisite amount of fuel. The fuel may be injected separately of the air (e.g. by direct fuel injection) or may accompany the air (e.g. by way of throttle body injection or multipart injection). In any event, the amount of fuel delivered is typically contingent upon the amount of air delivered as determined by the throttle setting. In order to achieve a change in speed with this arrangement, the throttle position must first be moved in order to secondarily achieve a commensurate fuelling change.

Flight requests demanding certain operating conditions for a UAV engine are commonly represented by commensurate throttle settings. In other words, a flight request may directly determine what throttle setting will be implemented during flight for the engine of the UAV.

In many cases the direct relationship between flight requests and throttle settings does not result in any engine operating concerns or issues. If, for example, there is a need for a change in engine torque and/or speed, this can be implemented through a commensurate change in throttle setting, particularly as the engine is coupled directly to a propeller or other propulsion device of the UAV. Put simply, an increase in throttle setting would normally lead to a proportionate increase in engine torque and/or speed, and a decrease in throttle setting would normally lead to a proportionate decrease in engine torque and/or speed.

However, the direct relationship between flight requests and throttle settings may become problematic in certain engine operation situations for certain engine arrangements. One such situation may be where a flight request demands a throttle setting which would impose an engine operating condition that would not be appropriate for the altitude or engine load to which the engine is exposed at that particular time. Such a request may for example cause the engine speed to drop below a prescribed limit identified as a minimum acceptable speed for reliable engine operation to avoid an engine stall condition. Another situation may be where a flight request demands a throttle setting that would cause the engine to over-speed, potentially leading to catastrophic engine failure.

It is against this background, and certain problems and difficulties associated therewith, that the present invention has been developed.

### SUMMARY OF INVENTION

According to a first aspect of the invention there is provided a method of controlling an internal combustion engine of a UAV, the engine having a fuel delivery means operable to deliver a fuel to a combustion chamber of the engine and a flow control means for regulating air flow to the combustion chamber, the method comprising controlling the engine through control of fuelling by way of the fuel delivery means independently of the flow control means, including determining a fuelling requirement for the engine based on a request from a flight control system and determining an air flow requirement based on or with reference to the fuelling requirement.

With such a method, fuelling may be controlled to accommodate any permissible variation in engine speed as may be required to deliver a resultant torque output for the engine

The air flow control means may comprise a throttle in which case the control of fuelling is independent of throttle setting.

The flow control means and the fuel delivery means may be operable independently of each other under the control of an electronic control unit.

The fuelling requirement (i.e. fuel demand) commensurate with a requested engine speed may be generated by reference to a data structure such as a look-up table or map. The look-up table or map may be stored in computer readable memory associated with the electronic control unit.

The fuelling requirement may be determined having regard to other factors including but not limited to any one or more of the following: altitude; engine temperature; and intake air temperature.

The air flow requirement (i.e. air demand) may be determined based on or with reference to the fuelling requirement.

The air flow requirement may also be determined having regard to other factors including but not limited to any one or more of the following: altitude; engine temperature; and intake air temperature.

Preferably, the method further comprises receiving the request from the flight control system, determining a fuelling requirement corresponding to the request; and controlling the fuelling of the engine accordingly.

In one arrangement, the flight request from the flight control system may be in the form of a request for a particular engine speed.

In another arrangement, the flight request may be in the form of a request for an arbitrary ‘engine demand’ between 0-100%. Depending on current engine operating conditions, commensurate adjustments to fuelling and then throttle position settings to modify the air-fuel ratio (if required) would be effected to meet this requested engine demand, which ultimately corresponds to a change in engine torque delivered.

The method may further comprise comparing a signal representative of the engine speed corresponding to the flight request with a signal representative of the actual engine speed to determine if any change in speed is required.

The method may further comprise a change in fuelling for the engine upon a determination of a requirement for a change of engine speed.

The method may further comprise providing an engine speed feedback loop. The engine speed feedback loop may be configured to adjust fuelling as required. The engine speed feedback loop may comprise a controller operable to adjust fuelling to reduce engine speed error and/or maintain engine speed at a target speed or set-point speed. The controller may comprise a PI controller.

The flight control system may comprise a flight controller in communication with or integrated into the electronic control unit.

According to a second aspect of the invention there is provided a UAV powered by an internal combustion engine controllable by a method according to the first aspect of the invention.

According to a third aspect of the invention there is provided a UAV engine system comprising a combustion chamber, flow control means for regulating air flow to the combustion chamber, and fuel delivery means operable to deliver fuel into a combustion chamber, wherein the flow control means and the fuel delivery means are operable independently of each other under the control of an electronic control unit, wherein a fuelling requirement is determined based on a request from a flight control system and a fluid flow requirement is determined based on or with reference to the fuelling requirement.

The flow control means may comprise a throttle.

The fuel delivery means may comprise a dual-fluid fuel injection system or a single-fluid fuel injection system.

The fuel delivery means may be operable to deliver fuel entrained in a gas directly into a combustion chamber.

The engine system may further comprise an engine speed feedback loop. The engine speed feedback loop may be configured to adjust fuelling as required. The engine speed feedback loop may comprise a controller operable to adjust fuelling to reduce engine speed error and/or maintain engine speed at a target speed or set-point speed. The controller may comprise a PI controller.

The engine system may comprise a spark-ignition engine or a compression-ignition engine.

The engine system may comprise a two-stroke or a four-stroke engine.

The engine system may comprise a single-cylinder or multi-cylinder engine.

The engine system may comprise a dual fluid fuel injection system or a single fluid fuel injection system.

According to a fourth aspect of the invention there is provided a UAV powered by an internal combustion engine forming part of the engine system according to the third aspect of the invention.

Preferably, the UAV further comprises a propulsion device (e.g. a propeller) connected directly to the engine.

### BRIEF DESCRIPTION OF THE DRAWINGS

Further features of the present invention are more fully described in the following description of an embodiment thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic representation of a UAV incorporating a prior art engine system;

FIG. 2 provides a graphical representation of certain conditions and events occurring during operation of the prior art engine system;

FIG. 3 is a graph depicting a typical variation between actual engine speed and target engine speed for the prior art engine system;

FIG. 4 is a schematic representation of a UAV incorporating an embodiment of an engine system according to the invention;

FIG. 5 is a graph of air-fuel ratio (AFR) with respect to engine load for the engine system of FIG. 4, and depicting a permissible boundary range for air-fuel ratio;

FIG. 6 provides a graphical representation of certain conditions and events occurring during operation of the engine system of FIG. 4;

FIG. 7 is a graphical representation of a typical variation between actual engine speed and target engine speed for the engine system of FIG. 4; and

FIG. 8 is series of four graphical representations identified respectively as (a) to (d) relating to various characteristics and conditions arising during operation of the engine system of FIG. 4.

The drawings shown are not necessarily to scale, with emphasis instead generally being placed upon illustrating the principles of the present disclosure.

The figures depict an embodiment exemplifying the principles of the present disclosure. The embodiment illustrates a certain configuration; however, it is to be appreciated that the inventive principles can be implemented by way of many different configurations, as would be obvious to a person skilled in the art, whilst still embodying any of the inventive principles. These configurations are to be considered within the embodiment described herein.

### DESCRIPTION OF EMBODIMENT

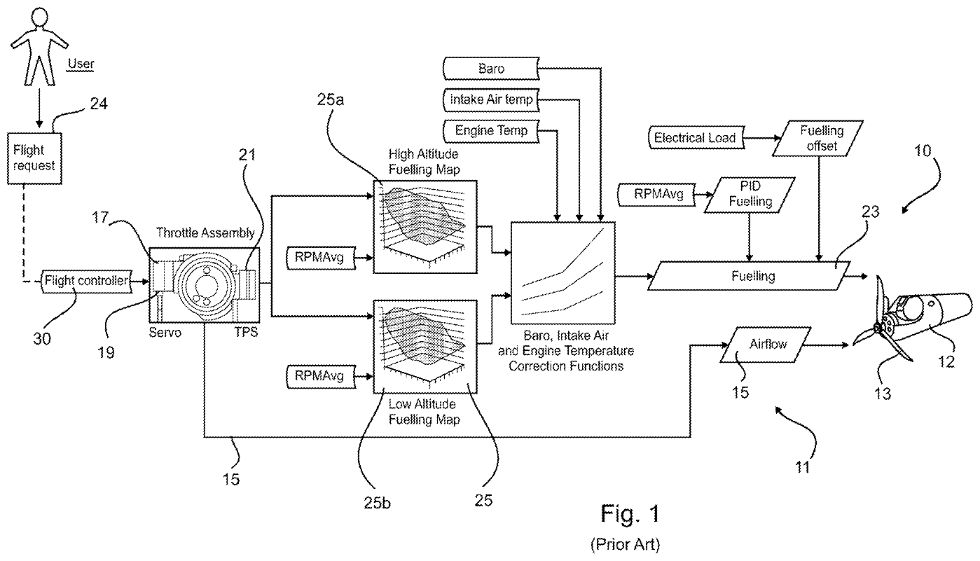

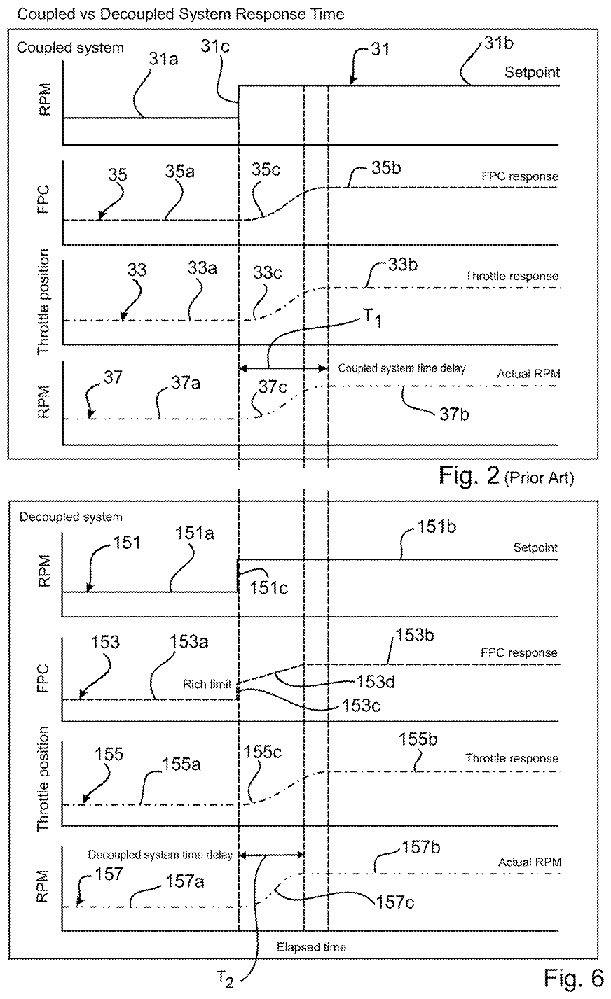

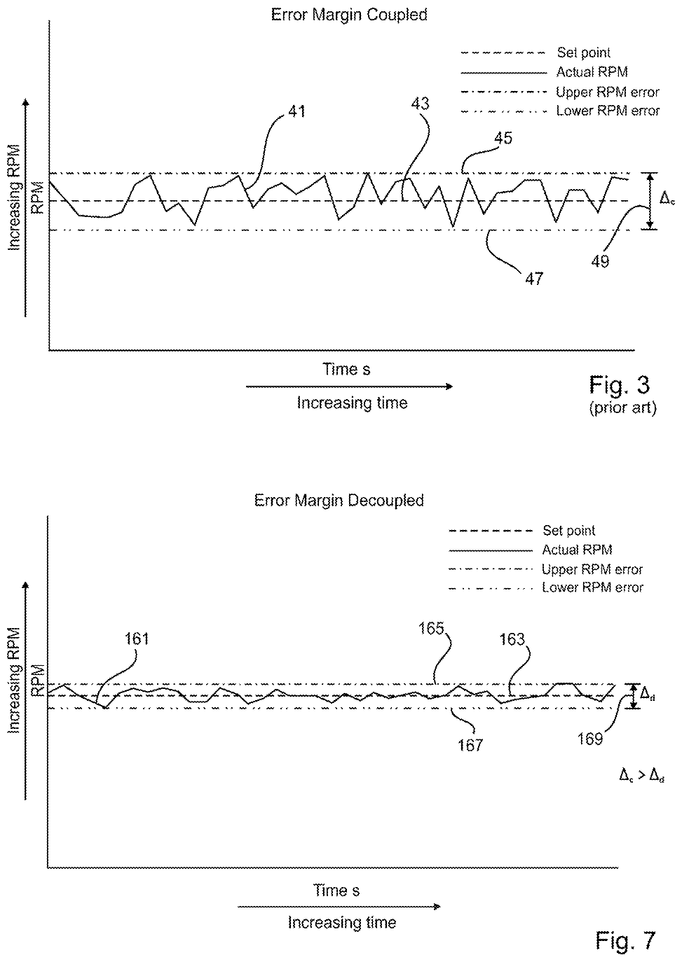

Before describing a UAV engine system and method of operation thereof according to the present invention in connection with a preferred embodiment, it will be useful to briefly review a prior art arrangement currently in use, in which the amount of fuel delivered is contingent upon the amount of air delivered as determined by a throttle setting (as discussed above as background art). In order to achieve a change in engine speed, the throttle setting must first be changed in order to secondarily achieve a fuelling change. In other words, the prior art system and method provides an air-based (throttle-based) control strategy in which fuelling is led by air flow (i.e. a throttle air-led system). An example of such a prior art engine system is depicted schematically in FIG. 1, and FIGS. 2 and 3 are graphical representations of certain conditions and events occurring during operation of the prior art engine system in response to a flight request imposing a change of throttle setting. In FIG. 2, the prior art system is identified as a “Coupled system”, reflecting the fact that fuel delivery is in a sense “coupled” to throttle setting in that the amount of fuel delivered is contingent upon the amount of air delivered as determined by the throttle setting (i.e. a throttle-led system).

Referring now to FIG. 1, there is schematically shown a UAV 10 incorporating the prior art engine system 11, The prior art engine system 11 comprises a small, single-cylinder reciprocating piston two-stroke engine 12 operating under the control of an electronic control unit (ECU) (not shown). The engine 12 is arranged to drive a propulsion element provided in the form of a propeller 13. An air intake system 15 is provided to deliver combustion air to a combustion chamber (not shown) of the engine 12. The air intake system 15 includes an air intake path (not shown) incorporating an air flow control means in the form of a throttle assembly 17 operable under the control of the ECU. The throttle assembly 17 comprises a throttle valve selectively movable into any angular position between fully open and fully closed conditions by a throttle position controller 19. The throttle position controller 19 comprises a servo motor operating under the control of an electronic throttle control module (not shown) in communication with or integrated into the ECU. The electronic throttle control module includes a throttle position sensor 21 (TPS). The engine system 11 further comprises a fuel injection system 23 by means of which fuel is delivered directly into the combustion chamber of the engine 12. The fuel injection system 23 operates under the control of the ECU. In this prior art arrangement, fuel injection system 23 comprises a dual-fluid direct injection system facilitating an air-assist fuel delivery process wherein fuel entrained in air is delivered directly into the combustion chamber of the engine 12.

The throttle assembly 17 is operable under the control of the ECU (via the throttle control module) in response to a flight request (identified schematically by block 24 in FIG. 1).

Engine power and speed can be selectively increased or decreased by control of the throttle assembly 17, with the angular position of the throttle valve regulating air flow along the air intake path within the air intake system 15 of the engine 12.

Fuel delivery is in effect “coupled” to throttle setting in that the amount of fuel then delivered is contingent upon the amount of air delivered as determined by the throttle setting. Specifically, a signal representative of the throttle setting (as determined by the throttle position sensor 21) is transmitted to the ECU which determines the fuelling requirement with reference to a fuelling map 25 providing fuelling rates as a function of throttle setting.

In the arrangement shown, there are two fuelling maps 25a and 25b provided for selection dependent upon altitude (e.g. high and low altitude fuelling maps respectively). Whilst the two fuelling maps 25a and 25b are targeted for high and low altitude respectively, it should be noted that the fuelling rate selected by the ECU is interpolated from the two maps according to the prevailing altitude. That is, the fuelling rate selected will typically be a value that is dependent on settings in both fuelling maps 25a and 25b (e.g. if the low altitude fuelling map is formulated for operation at sea level and the high altitude fuelling map is formulated for operation at say 15000 ft, then if the UAV is operating at 7500 ft, then the relevant condition is effectively halfway between these two altitude limits and the fuelling rate determined will be based on fuelling rate settings contained in both maps). It should also be noted that higher multiples (e.g. 3, 4, 5 etc) of the fuelling maps may also be used if that may assist with a more appropriate required fuelling rate being determined. Noting how the ECU typically interpolates a required fuelling rate from the multiple fuelling maps 25a and 25b, the ECU then controls the fuel injection system 23 to provide the required fuelling to the engine 12.

The UAV 10 has a flight control system incorporating a flight controller (identified by block 30).

In operating the UAV 10 remotely, a user can issue operational commands/signals via a remote controller, including flight requests 24 which demand certain engine operating conditions such as, for example, a particular engine speed or engine torque/power (noting that on an engine with a propeller, engine speed is directly proportional to torque). When the user issues a flight request (via the remote controller), the request is received by an on-board flight controller 30 and communicated to the ECU which assesses the request. If the ECU makes a determination to implement the request in a manner which would involve a change in throttle setting, the ECU would operate the throttle assembly 17 as necessary via the throttle control module.

In order to achieve a change in engine speed or engine torque/power, the throttle setting has to be changed in order to initiate a requisite fuelling change. This requires physical movement of the throttle valve of the throttle assembly 17, which is effected by the throttle position controller 19 (i.e. a servo motor) operating under the control of the electronic throttle control module in communication with or integrated into the ECU. This provides a relatively long feedback loop and can lead to significant delays (represented by multiple engine cycles or TDC passes) when engine speed changes are required by the user.

This delay can be further understood with reference to FIG. 2, which graphically depicts certain conditions and events occurring during operation of the engine system 11 in response to a flight request 24 entailing a change in desired or setpoint engine speed, as depicted by plot line 31. The plot line 31 has an initial section 31a representing an initial speed and a final section 31b representing a final speed, with an intermediate section 31c representing a step change between the two speeds. The final speed 31b may be considered as a target speed or desired engine speed set-point.

In response to the flight request 24, the ECU or throttle control module imposes a change to the throttle setting (i.e. throttle position), the movement of which is depicted by plot line 33. The plot line 33 has an initial section 33a representing an initial throttle setting and a final section 33b representing a final throttle setting. Because the throttle valve of the throttle assembly is required to move physically to enact changes in the air flow to the engine combustion chamber, the change from the initial setting 33a to the final setting 33b is progressive, as represented by intervening sloped section 33c.

The change in throttle position in turn leads to a change in fuelling in terms of fuel per cycle (FPC), as depicted by plot line 35. The plot line 35 has an initial section 35a representing an initial FPC amount and a final section 35b representing a final FPC amount. Because fuel delivery (i.e. FPC) is in effect “coupled” to throttle setting (in that the amount of fuel delivered is contingent upon the amount of air delivered as determined by the throttle position), the change from the initial FPC value to the final FPC value is progressive, as represented by intervening sloped section 35c.

The change in fuelling in turn leads to a change in actual engine speed, as depicted by plot line 37. The plot line 37 has an initial section 37a representing an initial speed (which corresponds to the initial speed represented by section 31a of plot line 31) and a final section 37b representing a final speed (which corresponds to the final speed represented by section 31b of plot line 31). Because the change in fuelling is progressive, the change from the actual initial speed to the actual final speed is also progressive, as represented by intervening sloped section 37c.

The progressive change in throttle position therefor introduces a time delay (depicted by line T₁ with reference to plot line 37) in achieving the desired setpoint engine speed. In other words, a flight request 24 which entails a step change in the desired or set-point engine speed as depicted by plot line 31, results in a delayed change in the actual engine speed as depicted by plot line 37, with the delay being T₁ on plot line 37.

The impact of the delay will now be discussed with reference to FIG. 3 which graphically represents engine speed with respect to time. The actual engine speed is depicted by plot line 41. Three other values of engine speed are also then identified in FIG. 3; namely, a set-point value 43 which represents a target engine speed, an upper value 45 which represents an upper engine speed error above the target engine speed, and a lower value 47 which represents a lower engine speed error below the target engine speed. The difference between upper value 45 and lower value 47 is Δ_{c} (identified by reference numeral 49).

When the engine 12 is running at a nominally constant speed, the engine system 11 seeks to maintain the engine speed at set-point speed 43. For a variety of reasons, variations from the set-point speed can arise; for example as a result of an electrical loading being applied to the engine. Action performed by the engine system 11 to correct a variation from the set-point speed necessitates a fuelling change (in order to achieve a change in actual engine speed). This in turn necessitates that the throttle setting be changed (in order to initiate a requisite fuelling change). This further requires physical movement of the throttle valve of the throttle assembly 17, which is effected by the throttle position controller 19 (i.e. a servo motor) operating under the control of the electronic throttle control module in communication with or integrated into the ECU. As previously explained, this provides a relatively long feedback loop and leads to a significant delay when seeking to modify the actual engine speed. This delay can bring about “over-correction”, leading to the actual engine speed fluctuating between upper value 45 of engine speed error and lower value 47 of engine speed error. The range of fluctuation is represented by Δ_{c} (identified by reference numeral 49).

In other words, there is a notable lag between a change in throttle position and a corresponding change in delivery of engine torque/power. This lag may be undesirable or problematic in certain circumstances.

With the above in mind, the present invention will now be described in connection with a preferred embodiment. To the extent that the following description is specific to a particular embodiment or a particular use of the present techniques, it is intended to be illustrative only and merely provides a concise description of the exemplary embodiment. Accordingly, the present invention is not limited to the specific embodiment described below, but rather the invention includes all alternatives, modifications, and equivalents falling within the true scope of the appended claims.

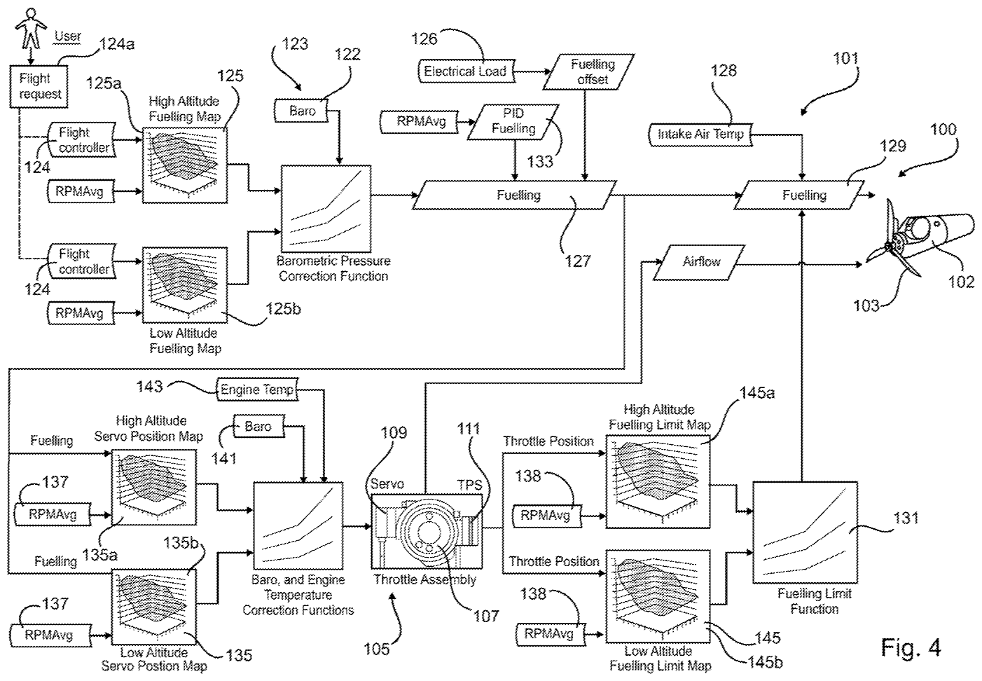

Referring now to FIG. 4, there is schematically shown a UAV 100 incorporating an engine system 101. The engine system 101 comprises a small, single-cylinder reciprocating piston two-stroke engine 102 operating under the control of an electronic control unit (ECU) (not shown). The engine 102 is arranged to drive a propulsion element provided in the form of a propeller 103. An air intake system 105 is provided to deliver combustion air to a combustion chamber (not shown) of the engine 102. The air intake system 105 includes an air intake path (not shown) incorporating an air flow control means in the form of a throttle assembly 107 operable under the control of the ECU. The throttle assembly 107 comprises a throttle valve selectively movable into any angular position between fully open and fully closed conditions by a throttle position controller 109 in the form of a servo motor operating under the control of an electronic throttle control module (not shown) in communication with or integrated into the ECU. The electronic throttle control module includes a throttle position sensor 111 (TPS). The engine system 101 further comprises a fuel delivery means comprising a fuel injection system 123 by means of which fuel is delivered directly into the combustion chamber of the engine 102. The fuel injection system 123 operates under the control of the ECU. The fuel injection system 123 may comprise a dual-fluid direct injection system facilitating an air-assist fuel delivery process wherein fuel entrained in air is delivered directly into the combustion chamber of the engine 102. Other forms of fuel injection system are however also contemplated for use with the present invention.

The fuel injection system 123 is operable under the control of the ECU in response to a flight request (identified schematically by block 124a in FIG. 4). The throttle assembly 107 is also operable under the control of the ECU (via the throttle control module). However, operation of the fuel injection system 123 is not linked to operation of the throttle assembly 107, as was the case in the prior art arrangement discussed above and with respect to FIG. 1. Rather, the present arrangement provides a fuel-led control system instead of a throttle or air-led control system.

Engine torque/power and speed can be selectively increased or decreased by control of the fuel injection system 123, regulating fuel delivery to the combustion chamber of the engine 102. The throttle assembly 107 is then operated in response to the fuel requirement under the control of the ECU (via the throttle control module), as will be explained in more detail later.

In response to a flight request 124a sent via the onboard flight controller (identified schematically by block 124 in FIG. 4), a signal representative of the request is transmitted to the ECU. The ECU compares the current engine speed to a target engine speed commensurate with the flight request 124a. If there is a determination by the ECU that the flight request entails a change in engine speed (or torque) which necessitates a variation in fuelling, the ECU determines the necessary fuelling requirement with reference to a fuelling map 125 which provides fuelling rates as a function of engine speed (or torque).

In the arrangement shown, there are two fuelling maps 125a and 125b provided for selection dependent upon altitude (e.g. high and low altitude respectively). As was the case with the prior art system explained with reference to FIG. 1, the fuelling rate selected by the ECU is typically interpolated from the two fuelling maps according to the prevailing altitude (i.e. the required fuelling rate will typically be a value that is dependent on settings in both fuelling maps 125a and 125b). Again, it should also be noted that higher multiples (e.g. 3, 4, 5 etc) of the fuelling maps may also be used if that may assist with a more appropriate required fuelling rate being determined. The ECU then controls the fuel injection system 123 to provide the required fuelling.

In the arrangement shown, the ECU has provision to provide fuelling offsets (which are correction functions) to take into account certain factors, such as for example barometric pressure (identified schematically by block 122 in FIG. 4), and any parasitic loading on the engine (e.g. electrical load as identified schematically by block 126). More particularly, the ECU makes a base fuelling determination (identified by block 127 in FIG. 4) from reference to the respective fuelling map 125 and the various correction factors. After accounting for air temperature (identified schematically by block 128), the ECU makes a revised fuelling determination (identified by block 129) and implements the revised fuelling setting accordingly.

The revised fuelling determination (identified by block 129) may also be a function of a predetermined fuelling limit (identified by block 131). Specifically, a determination is made as to whether the resultant air-fuel ratio within the combustion chamber would be within a permissible boundary range between upper and lower limits to provide for stable combustion, as will be explained in more detail later.

The ECU features an engine speed feedback loop incorporating a PI controller (identified schematically by block 133 in FIG. 4). Within the PI controller, a proportional and integral constant algorithm restores actual engine speed to desired (target) speed in an optimum way.

As mentioned above, air flow is now determined as a function of the fuel determination. As such, in addition to being delivered as an input for the revised fuelling determination (identified by block 129), the output of the base fuelling determination (identified by block 127) is delivered as an input to a throttle position map 135. The throttle position map 135 also references engine speed (identified schematically as an input by block 137 in FIG. 4). The throttle position map 135 provides throttle settings as a function of fuelling requirement, as derived from the base fuelling determination (identified by block 127). In the arrangement shown, there are two throttle position maps 135a and 135b provided for selection dependent upon altitude (e.g, high and low altitude respectively). As was previously described with respect to fuelling rate, the throttle setting selected by the ECU is typically interpolated from the two throttle position maps 135a and 135b according to the prevailing altitude (i.e. the required throttle setting will typically be a value that is dependent on settings in both throttle position maps). It should also be noted however that multiple altitude maps (e.g. 3, 4 or 5 etc) may be employed in certain engine systems where specific engine or UAV operation may dictate this is preferred, with the required throttle position similarly being determined based on the settings in the multiple maps. The ECU then controls the throttle assembly 107 as necessary via the throttle control module to provide the required intake air for the combustion chamber of the engine 102.

In the arrangement shown, the ECU has provision to provide offsets (correction functions) in relation to throttle position to take into account certain factors, such as for example barometric pressure (identified schematically by block 141 in FIG. 4), and engine temperature (identified schematically by block 143).

The fuelling limit function (identified by block 131) as previously referred to references a fuelling limit map 145. The fuelling limit map 145 references throttle position and engine speed (identified schematically as an input by block 138 in FIG. 4). In the arrangement shown, there are two fuelling limit maps 145a and 145b provided for selection dependent upon altitude (e.g. high and low altitude respectively). As was previously described with respect to fuelling rate, the fuelling limit selected by the ECU is typically interpolated from the two fuelling limit maps 145a and 145b (or multiple fuelling limit maps (e.g. 3, 4, 5 etc) in another scenario) according to the prevailing altitude (i.e. the required fuelling limit will typically be a value that is dependent on settings in the multiple fuelling limit maps).

As mentioned above, the fuelling limit function provides determination as to whether the resultant air-fuel ratio would be within a permissible boundary range between upper and lower limits. This is to ensure adherence to specific air-fuel ratio boundaries in order to, for example, achieve suitable combustion repeatability.

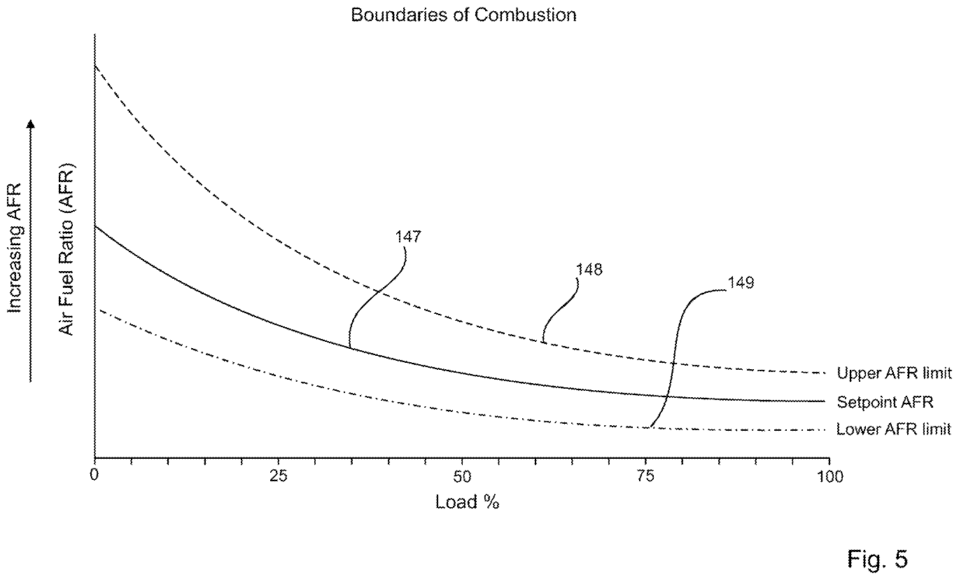

The nature of the permissible boundary range for air-fuel ratio will be explained further with reference to FIG. 5 which is a graphical representation of air-fuel ratio (AFR) with respect to engine load (by percentage). In FIG. 5, there are three plots of AFR; namely; setpoint AFR 147, an upper AFR limit 148 (constituting the leanest mixture permissible) and a lower AFR limit 149 (constituting the richest AFR permissible). From FIG. 5 it can be seen that the range or band between the upper and lower AFR limits diminishes proportionally with increasing engine load. Accordingly, there is a need to ensure that the throttle setting is appropriate to provide air flow at a rate commensurate with fuel delivery to sustain an AFR within the permissible boundary range, having regard to the particular engine load. The fuelling limit function (identified by block 131) enables the ECU to make such a determination and act accordingly.

In regard to the fuelling limit function (identified by block 131), it should be noted that, whilst this has been described above as referencing a pair of fuelling limit maps 145a and 145b (or multiple maps more generally) to ensure an air flow rate which is commensurate with fuel delivery to sustain an AFR within the permissible boundary range, it may also be the case that a pair (or multiple) fuelling limit maps are provided in respect of each of the upper and lower AFR limits. That is, the engine system 101 may provide a specific pair of (or multiple) fuelling limit maps for the lean AFR limit (i.e. upper AFR limit 148) and a specific pair of (or multiple) fuelling limit maps for the rich AFR limit (i.e. lower AFR limit 149). In this way the most appropriate fuelling rate, and hence resultant throttle position setting, for the upper AFR limit 148 (constituting the leanest mixture possible) can be interpolated from unique multiple fuelling limit maps that make allowances for the prevailing altitude, and the most appropriate fuelling rate, and hence resultant throttle position setting, for the lower AFR limit 149 (constituting the richest mixture possible) can be interpolated from unique multiple fuelling limit maps that similarly make allowances for the prevailing altitude.

From the foregoing, it is evident that the present embodiment provides for fuel-led control of the engine system 101. Specifically, a fuelling requirement for the engine 102 is determined and implemented by the ECU, and the corresponding air requirement is then determined contingent upon the fuelling requirement.

The closed loop speed control is fuel-led and therefore fuelling can be adjusted independently of air flow (within specific air-fuel ratio boundaries that are required to be adhered to in order to achieve suitable combustion repeatability (as discussed above)).

This fuel-led control of the engine system 101 provides certain advantages over throttle or air-led control. One particular advantage relates to a reduction in response time in relation to permissible flight requests, whilst another advantage relates to enhanced accuracy in maintaining a set engine speed (i.e. limiting over-correction from a set-point by reducing the time delay for a fuelling change to be applied). In essence, the improvement in maintaining a target or setpoint engine speed is due to the faster response in terms of changes to engine speed which is a consequence of the engine system 101 being fuel led (i.e. changes to engine speed do not require waiting for the throttle valve of the throttle assembly 107 to be actuated (mechanical/slow operation)—rather changes to the fuelling rate are in effect immediate as they can be updated each TDC).

These advantages may be better understood with reference to FIGS. 6 and 7 which are graphical representations of certain conditions and events occurring during operation of the engine system 101 in response to a flight request 124a imposing a change of engine speed or torque. In FIG. 6, the system is identified as a “Decoupled system”, reflecting the fact that fuel delivery is in a sense “decoupled” from throttle setting whereby the amount of fuel delivered is not contingent upon the amount of air delivered as determined by the throttle setting.)

FIGS. 6 and 7 are portrayed in association with counterpart FIGS. 2 and 3 of the prior art arrangement discussed previously in order to assist in better understanding differences between the fuel-led and throttle led control systems.

In operating the UAV 100 remotely, a user can issue operational commands/signals via a remote controller, including flight requests 124a which demand certain engine operating conditions such as, for example, a particular engine speed or engine torque/power. When the user issues a flight request (via the remote controller), the request is received by the on-board controller 124 and communicated to the ECU which assesses the request. If the ECU makes a determination to implement the request in a manner which would involve a change in the fuelling requirement, the ECU would operate the fuel injection system 123 as further described below.

In order to achieve a change in engine speed or engine torque/power, the ECU operates the fuel injection system 123 to bring about a rapid (i.e. an almost immediate) change in fuelling (FPC), thereby reducing lag time in implementing the flight request 124a. If the change necessitates a change in air flow and thus a change in throttle position, there is still a need for physical movement of the throttle valve of the throttle assembly 107, which is effected by the throttle position controller 109 (servo motor) operating under the control of the electronic throttle control module in communication with or integrated into the ECU. This does not, however, delay implementation of the flight request, as the engine control is now fuel-led.

Accordingly, the control response is faster in this fuel-led system, as fuelling can be changed as necessary (for example on a TDC basis) without first having to wait for throttle movement. This is in contrast to a throttle-led system where in order to achieve a change in speed, the throttle position must first be moved in order to secondarily achieve a fuelling change.

This can be further understood with reference to FIG. 6, which graphically depicts certain conditions and events occurring during operation of the engine system 101 in response to a flight request 124a entailing a change in engine speed, as depicted by plot line 151. The plot line 151 has an initial section 151a representing an initial speed and a final section 151b representing a final speed, with an intermediate section 151c representing a step change between the two speeds. The final speed 151b may be considered as a target or set-point speed.

In response to the flight request, the ECU operates the fuel injection system 123 to impose a change to the fuelling rate (FPC), as depicted by plot line 153. The plot line 153 has an initial section 153a representing the original FPC and a final section 153b representing the final FPC. In response to the change to fuelling rate (FPC), there may be an initial step-change represented by section 153c (through for example momentary delivery of a burst of a fuel-rich mixture) followed by a progressively increasing change represented by section 153d.

In the arrangement shown, the change to fuelling rate (FPC) brings about a change in throttle position, as depicted by plot line 155. The plot line 155 has an initial section 155a representing an initial setting and a final section 155b representing a final setting. Because the throttle valve is required to move physically, the change from the initial setting 155a to the final setting 155b is progressive, as represented by intervening sloped section 155c.

It is notable that the response time for the change in throttle position in this fuel-led control system is the same as the response time for the change in throttle position in the throttle-led control system as shown in FIG. 2.

The change in fuelling leads to a change in actual engine speed, as depicted by plot line 157. The plot line 157 has an initial section 157a representing an initial speed (which corresponds to the initial speed represented by section 151a of plot line 151) and a final section 157b representing a final speed (which corresponds to the final speed represented by section 151b of plot line 151). Because the change in fuelling is progressive, the change from the actual initial speed to the actual final speed is also progressive, as represented by intervening sloped section 157c.

There remains some time delay between the fuel-led control system invoking a change to the fuelling rate (FPC) and the engine attaining the final speed (which may be a target speed or a set-point speed). This time delay is depicted by line T₂ with reference to plot line 157 in FIG. 6).

It is notable however that the time delay T₂ in this fuel-led control system is less than the corresponding time delay T₁ in the throttle-led control system as shown in FIG. 2. As mentioned previously, the control response is faster in this fuel-led system, as fuelling can be changed as necessary (for example on a TDC basis) without first having to wait for throttle movement.

It is also worth noting that, in a case where the setpoint speed is only required to change by a relatively small amount, the control response could be even faster than the scenario just described. In such a case the change in fuelling rate (FPC) can be instant and wholly applied because the engine speed change can be effected with a fuelling rate change that is not limited by movement of the throttle valve of the throttle assembly 107. That is, the whole fuelling change can be applied at once because the rich limit is not exceeded. The throttle position may still need to be moved to achieve the new engine speed target or setpoint, but during transition this does not limit the fuelling change. This is particularly so for the applicant's air-assisted DI injection engine systems which have very good tolerance to rich and lean AFR limits, particularly when operating in a more stratified environment. This helps facilitate how fuelling rate is able to be changed without any significant limitation (i.e. for smaller engine speed target changes) thereby enabling a very quick change in engine speed response.

The impact of delay T₂ will now be further discussed with reference to FIG. 7 which graphically represents engine speed with respect to time. The actual engine speed is depicted by plot line 161. Three other values of engine speed are also then identified in FIG. 7; namely, a set-point value 163 which represents a target engine speed, an upper value 165 which represents an upper engine speed error above the target engine speed, and a lower value 167 which represents a lower engine speed error below the target engine speed. The difference between the upper value 165 and lower value 167 is Δ_{d} (identified by reference numeral 169).

It is notable that the difference between the upper and lower engine speed error Δ_{d} in this fuel-led control system is significantly less than the difference between the upper and lower engine speed error Δ_{c} in the throttle-led control system as shown in FIG. 2.

When the engine 102 is running at a nominally constant speed, the engine system 101 seeks to maintain the engine speed at the set-point speed 163. For a variety of reasons, variations from the set-point speed can arise; for example an electrical loading may be imposed on the engine 102. This may cause a variation between the actual engine speed and the target engine speed (set-point speed). This variation may be considered to be a speed error which requires correction. The engine speed feedback loop incorporating the PI controller (identified schematically by block 133 in FIG. 4) acts to adjust fuelling to reduce the speed error and maintain the engine speed at the target speed (set-point).

Action performed by the engine system 101 by way of the engine speed feedback loop to correct a speed variation from the set-point speed, may necessitate a fuelling change. In this fuel-led control system, the change can be implemented rapidly (almost immediately). There is nevertheless some delay in response, which can bring about some “over-correction”, leading to the actual engine speed fluctuation through Δ_{d} between upper value 165 of engine speed error and lower value 167 of engine speed error.

For a UAV application such as that described with reference to FIGS. 2 and 4, the ability of a fuel-led system to respond immediately to a measured engine speed target error is significant in that it enables maintaining a reduced engine speed targeting error during flight operation. For example, in respect of the operation of UAVs, it is understood that aircraft manoeuvers such as changes in aircraft attitude towards or away from wind direction or changes of direction resulting from banking typically apply load to the engine which normally affect the actual engine speed. In prior art systems (such as that described with respect to FIG. 1), this would typically necessitate additional input from the user via the flight controller in seeking to maintain a target engine speed. However, by way of the subject invention fuel led system (as described with reference to FIG. 4) and its ability to better target a desired engine speed, the engine controller is effectively able to maintain the target engine speed during such aircraft manoeuvers without additional input from the user (i.e. like it would if electrical parasitic loads were applied to the engine).

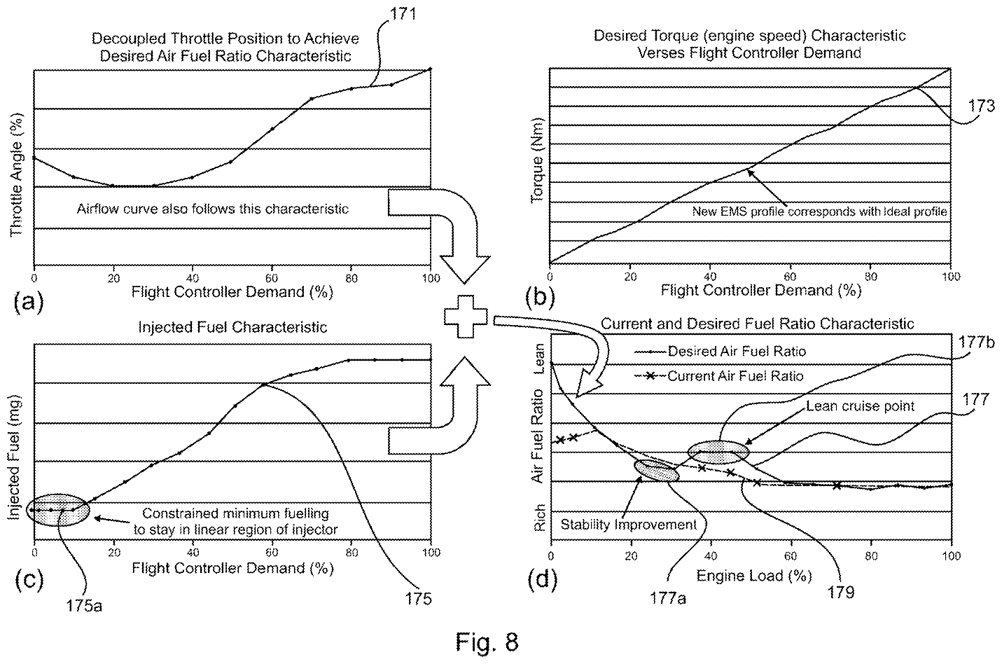

Referring now to FIG. 8 there is depicted a series of four graphical representations identified respectively as (a) to (d) relating to various characteristics and conditions arising during operation of the subject invention fuel led system when applied to a UAV (as described with reference to FIG. 4). The four graphical representations (a) to (d) are integrated into FIG. 8 because of the interrelationship between certain conditions and events that are depicted.

FIG. 8(a) illustrates the decoupled throttle position to achieve a desired air-fuel ratio characteristic, as depicted by plot line 171. The airflow characteristic follows this air-fuel ratio characteristic (i.e. the profile of plot line 171).

FIG. 8(b) illustrates the desired torque (engine speed) characteristic versus flight controller demand, as depicted by plot line 173.

FIG. 8(c) illustrates the injected fuel characteristic versus flight controller demand, as depicted by plot line 175. It is notable that plot line 175 has section 175a depicting a constrained minimum fueling condition to stay within the linear fuel delivery region of a fuel injector to ensure reliability of delivery.

FIG. 8(d) illustrates a desired air-fuel ratio characteristic versus engine load during operation of the subject invention fuel led system (as depicted by plot line 177 and identified as “Desired Air Fuel Ratio”). For the purposes of comparison and contrast, there is also shown an air-fuel ratio characteristic versus engine load during operation of a known prior art system such as that described hereinbefore with reference to FIG. 1 (as depicted by plot line 179 and identified as “Current Air Fuel Ratio”).

FIGS. 8(a) and 8(c) together depict the link between fuel delivery and the throttle (which is effectively decoupled from user/operator demand).

Decoupling the fuelling rate (FPC) from the throttle position enables the throttle position to be set independently of torque/fuelling in specific regions of engine operation. By way of example, a region of operation can be either enriched or enleaned as may be desired to provide a preferred AFR for the engine. This can be seen in FIG. 8(d) where region 177a of plot line 177 is able to be enriched (e.g. to enhance stability of combustion and engine run quality), and region 177b of plot line 177 is able to be enleaned (e.g. to provide fuel economy benefits where the engine/UAV is operating in a cruise condition).

As alluded to above, fuel-led control of the engine system 101 (i.e. where the link between the throttle and user/operator demand is effectively broken or decoupled) provides certain advantages over throttle-led control. In addition to advantages associated with more rapid response times (as discussed above) and being able to demand a specific engine torque (i.e. recognising that on an aircraft engine which drives a propeller, engine speed is directly proportional to torque), other advantages may arise as a result of separation between fuelling and air flow (i.e. as determined by throttle position).

For instance, an optimal air-fuel ratio may be targeted at different engine loads (as depicted by plot line 177 in FIG. 8 (d)) by controlling the throttle position independently of fuelling. This may be particularly so as injected fuel (FPC) is increased. In other words, as injected fuel is increased, the optimal AFR for combustion and fuel economy for the engine can be targeted at different engine loads by modulating the throttle position independently of the fuelling.

Further, it would be possible to increase fuelling without there being any change to air flow, if so desired. Similarly, it would be possible to increase fuelling while reducing airflow, if so desired. Hence greater flexibility and advantages are able to be realised by way of such a fuel-led control system, including in respect of fuel consumption benefits, greater flexibility around AFR control and combustion stability benefits. This is particularly so in respect of certain direct injected stratified charge lean burn engines which have a wide ranging AFR tolerance, particularly at lighter engine loads where high levels of fuel stratification are achievable.

Still further, as fuel is effectively directly proportional to torque in a stratified lean direct injection engine system, a performance characteristic featuring linear torque progression may be maintained with increasing flight controller demand without compromising the air-fuel ratio (i.e. with the ability to significantly dictate and vary throttle and fuelling settings whilst still providing an increasing torque profile in the eyes of the user).

Furthermore, as the engine system 101 features the engine speed feedback loop to correct a speed variation from the set-point speed, any parasitic loading (such as electrical loading) imposed upon the engine 102 can be addressed and corrected relatively quickly.

Advantages such as those highlighted above are particularly noteworthy when considering engine systems of UAVs which by their very nature require to be very responsive to different conditions and operating requirements, whilst still being able to meet expected fuel consumption and performance benefits. The ability to gain more direct and faster-acting control over engine speed (and hence engine torque) while accounting for prevailing operating conditions enables better engine and flight operation for such UAVs.

The foregoing disclosure is intended to explain how to fashion and use the particular embodiment described, rather than to limit the true, intended, and fair scope and spirit of the present disclosure. The foregoing description is not intended to be exhaustive, nor to be limited to the precise forms disclosed.

It should be appreciated that various modifications can be made without departing from the principles described herein. Therefore, the principles should be understood to include all such modifications within its scope.

While the embodiment described herein was primarily developed and discussed in relation to a single-cylinder engine, it should be understood that the principles applied herein may have application to multi-cylinder configurations. In the case of a multi-cylinder engine, fuelling may be controlled on a cylinder-by-cylinder basis. In such a case, the fuelling may be controlled at a fixed point in the cycle of each cylinder, such as for example at a fixed point before TOO. This may provide an improved response time, as there would be a very short delay after registering an engine target speed or set-point error before responding to the error.

Further; the engines may be either spark-ignition engines or compression-ignition engines, as well as both two-stroke and four-stroke engines. Still further, the engines may comprise either a dual-fluid fuel injection system or a single-fluid fuel injection system.

In the embodiment described there is reference to mapping. It will be appreciated that this is to be taken to include reference to a look-up table or other data structure. The map, look-up table or other data structure may be stored in computer readable memory associated with the electronic control unit (ECU).

The terminology used herein is for the purpose of describing a particular example embodiment only and is not intended to be limiting.

As used herein, the singular forms “a”, “an” and “the” may be intended to include the plural forms as well, unless the context clearly indicates otherwise.

The method steps, processes, and operations described herein are not to be construed as necessarily requiring their performance in the particular order discussed or illustrated, unless specifically identified as an order of performance. It is also to be understood that additional or alternative steps may be employed.

Reference to any positional descriptions, such as “top”, “bottom” and “side”, are to be taken in context of the embodiment described and are not to be taken as limiting the invention to the literal interpretation of the term but rather as would be understood by the skilled addressee.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiment.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g, “between” versus “directly between,” “adjacent” versus “directly adjacent,” etc.). As used herein, the term “and/or” includes any and all combinations of one or more of the associated listed items.

Additionally, where the terms “system”, “device”, and “apparatus” are used in the context of the invention, they are to be understood as including reference to any group of functionally related or interacting, interrelated, interdependent or associated components or elements that may be located in proximity to, separate from, integrated with, or discrete from, each other.

Furthermore, in the embodiment described herein (including the following claims), the word “determining” is understood to include receiving or accessing the relevant data or information.

Throughout this specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

Future patent applications maybe filed in Australia or overseas on the basis of, or claiming priority from, the present application. It is to be understood that the following claims are provided by way of example only, and are not intended to limit the scope of what may be claimed in any such future application. Features may be added to or omitted from the provisional claims at a later date so as to further define or re-define the invention or inventions.

1.-26. (canceled)

27. A method of controlling an internal combustion engine of a UAV, the engine having a fuel delivery means operable to deliver a fuel to a combustion chamber of the engine and a flow control means for regulating air flow to the combustion chamber, the method comprising controlling the engine through control of fuelling by way of the fuel delivery means independently of the flow control means over the engine speed and load range, including determining a fuelling requirement for the engine based on a request from a flight control system, and determining an air flow requirement based on or with reference to the fuelling requirement.

28. The method according to claim 27 wherein the flow control means comprises a throttle and whereby the control of fuelling is independent of throttle setting.

29. The method according to claim 27 wherein the flow control means and the fuel delivery means are operable independently of each other under the control of an electronic control unit.

30. The method according to claim 27, wherein the fuelling requirement commensurate with a requested engine speed is generated by reference to a data structure.

31. The method according to claim 27, wherein the fuelling requirement is determined having regard to other factors including any one or more of the following: altitude; engine temperature; and intake air temperature.

32. The method according to claim 31 wherein the air flow requirement is further determined having regard to other factors including any one or more of the following: altitude; engine temperature; and intake air temperature.

33. The method according to claim 27, further comprising receiving the request from the flight control system, determining a fuelling requirement corresponding to the request, and controlling the fuelling of the engine accordingly.

34. The method according to claim 27, wherein the flight request from the flight control system comprises a request for a particular engine speed.

35. The method according to claim 27, wherein the flight request from the flight control system comprises a request for an arbitrary ‘engine demand’ between 0-100% engine demand.

36. The method according to claim 27, further comprising comparing a signal representative of the engine speed corresponding to the flight request with a signal representative of the actual engine speed to determine if any change in speed is required.

37. (canceled)

38. The method according to claim 27, further comprising providing an engine speed feedback loop configured to adjust fuelling as required.

39. (canceled)

40. The method according to claim 38, wherein the engine speed feedback loop comprises a controller operable to adjust fuelling to reduce engine speed error and/or maintain engine speed at a target speed or set-point speed.

41. The method according to claim 29, further comprising a flight controller in communication with or integrated into the electronic control unit.

42. The method according to claim 27, further comprising determining whether air fuel ratio is within a permissible boundary range between upper and lower air fuel ratio limits.

43. The method according to claim 42, wherein throttle setting is set to provide air flow at a rate commensurate with fuelling requirement to sustain air-fuel ratio within the permissible boundary range having regard to engine load.

44. A UAV powered by an internal combustion engine controllable by a method according to claim 27.

45. A UAV engine system comprising a combustion chamber, flow control means for regulating air flow to the combustion chamber, and fuel delivery means operable to deliver fuel into a combustion chamber, wherein the flow control means and the fuel delivery means are operable independently of each other under the control of an electronic control unit, and wherein a fuelling requirement is determined based on a request from a flight control system and a fluid flow requirement is determined based on or with reference to the fuelling requirement over the engine speed and load range.

46. (canceled)

47. (canceled)

48. The UAV engine system according to claim 45,
wherein the fuel delivery means is operable to deliver fuel entrained in a gas directly into a combustion chamber.

49. The UAV engine system according to claim 45, further comprising an engine speed feedback loop.

50. (canceled)

51. The UAV engine system according to claim 49, wherein the engine speed feedback loop comprises a controller operable to adjust fuelling to reduce engine speed error and/or maintain engine speed at a target speed or set-point speed.

52. (canceled)

53. The UAV engine system according to claim 45, further comprising determining whether air fuel ratio is within a permissible boundary range between upper and lower air fuel ratio limits.

54. The UAV engine system according to claim 53, wherein a throttle setting is set to provide air flow at a rate commensurate with fuelling requirement to sustain air fuel ratio within the permissible boundary range having regard to engine load.

55. (canceled)

56. (canceled)
